(19) United States
(12) Patent Application Publication
(10) Pub. No.: US 2023/0033940 A1
(43) Pub. Date: Feb. 2, 2023

(54) PADDLE BOARD

(71) Applicant: Zhongshan Dragonfly Sports Equipment Co., Ltd., Zhongshan (CN)

(72) Inventors: PAK CHEUNG HO, Zhongshan (CN); SUK MING HO, Zhongshan (CN)

(21) Appl. No.: 17/647,452

(22) Filed: Jan. 8, 2022

(30) Foreign Application Priority Data
Jul. 30, 2021 (CN) 202121777780.2

(51) Int. Cl. B63B 32/50; B63B 32/40; B63B 32/57; B32B 5/18; B32B 5/24; B32B 5/26; B32B 27/36; B32B 27/30; B32B 27/32; B32B 27/12; B32B 27/28

(52) U.S. Cl. CPC B63B 32/50; B63B 32/40; B63B 32/57; B32B 5/18; B32B 5/245; B32B 5/26; B32B 27/365; B32B 27/308; B32B 27/306; B32B 27/32; B32B 27/12; B32B 27/28; B32B 2250/05; B32B 2307/3065; B32B 2307/714; B32B 2307/7265; B32B 2307/734; B32B 2262/101; B32B 2266/0221; B32B 2307/7163

(57) ABSTRACT

The present invention provides a surf board, comprising a body, and a bottom board layer and a protective layer which are respectively arranged at the two sides of the body; the body comprises a first fiber glass fiber layer arranged on the bottom board layer, an inner core arranged on the first fiber glass layer and a second fiber glass layer arranged on the inner core and connected with the protective layer; the second fiber glass layer is provided with two layers. In the present invention, the bottom board layer is arranged at the lower end of the body, so that the bottom of surf board is firmer. The protective layer is arranged at the upper end of the body, so that the surface of the surf board is protected and is prevented from being damaged due to strong water pressure when the surf board is used.

### CROSS-REFERENCE TO RELATED APPLICATIONS

This application claims the benefit and priority of China patent application No. 202121777780.2 filed on Jul. 30, 2021, disclosure of which is hereby incorporated by reference in its entirety.

### TECHNICAL FIELD

The present invention relates to the technical field of a sport equipment, especially relates to a paddle board.

### BACKGROUND

Paddle sport is a rowing sport that the rower stands or sits on the paddle and rows in the forward direction by holding the paddle. The quality of the paddles is particularly important in the rowing boat sport. Most paddles on the market are synthesized by glass fiber cloth and resin. The weight of the paddles is large. The bottom of the paddles is not firm enough. Paint spraying treatment is needed after the manufacture is finished. The environment pollution is large, and the environment protection concept is not met.

### SUMMARY

The present invention provides a paddle board for solving the technical problem provided in the background technology.

The present invention provides a paddle board, which comprises a body, and a bottom board layer and a protective layer which are arranged on the two sides of the body; the body comprises a first glass fiber layer arranged on the bottom board layer, an inner core arranged on the first glass fiber layer and a second glass fiber layer arranged on the inner core and connected with the protective layer; the second glass fiber layer is provided with two layers.

Furthermore, the material of bottom board layer is PC or ABS.

Furthermore, the material of the protective layer is EVA or PE.

Furthermore, the material of the inner core is foam.

Furthermore, the material of the first glass fiber layer is glass fiber cloth.

Furthermore, the material of the second glass fiber layer is glass fiber cloth.

The beneficial effects of the present invention are that: the bottom board layer is arranged at the lower end of the body, so that the bottom of the paddle board is firmer; the protective layer is arranged at the upper end of the body, so that the surface of the paddle board is protected, and the surface of the paddle board is prevented from being damaged due to strong water pressure when the paddle board is used; the bottom of the body is equipped with one layer of the first glass fiber layer and the top of the body is equipped with two layers of the second glass fiber layer, so that the connection between the bottom board layer with the body and the connection between the body and the protective layer are more stable.

### BRIEF DESCRIPTION OF DRAWINGS

FIG. 1 is an exploded view of the paddle board of the present invention.

FIG. 2 is a cross-sectional view of a paddle board of the present invention.

FIG. 3 is a diagram of one embodiment of a paddle board of the present invention.

### DETAILED DESCRIPTION

Reference will now be made in detail to the embodiments of the present invention, examples of which are illustrated in the accompanying drawings, wherein like reference numerals refer to the same or similar elements or elements having the same or similar functions throughout. The embodiments described below by referring to the drawings are exemplary intended for explaining the present invention, and should not be construed as limiting the present invention.

In the description of the present invention, it is to be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like indicate orientations or positional relationships based on the orientations or positional relationships shown in the drawings, and are only for convenience of description and simplification of the description, but do not indicate or imply that the device or element referred to must have a particular orientation, be constructed and operated in a particular orientation, and therefore, should not be construed as limiting the present invention.

Furthermore, the terms “first” and “second” are used for descriptive purposes only and are not to be construed as indicating or implying relative importance or to implicitly indicate the number of technical features indicated. Thus, a feature defined as “first” or “second” may explicitly or implicitly includes one or more of that feature. In the description of the present invention, “a plurality” means two or more unless specifically limited otherwise.

In the present invention, unless otherwise explicitly specified or limited, the terms “mounted,” “connected,” “secured,” and the like are to be construed broadly, e.g., as being fixedly connected, detachably connected, or integrally connected; can be mechanically or electrically connected; they may be connected directly or indirectly through intervening media, or they may be interconnected between two elements. The specific meaning of the above terms in the present invention can be understood according to specific situations by those of ordinary skill in the art.

In the present invention, unless expressly stated or limited otherwise, the recitation of a first feature “on” or “under” a second feature may include the recitation of the first and second features being in direct contact, and may also include the recitation of the first and second features not being in direct contact, but being in contact with another feature between them. Also, the first feature “on,” “above” and “over” the second feature may include the first feature being directly above and obliquely above the second feature, or simply indicating that the first feature is at a higher level than the second feature. The first feature “beneath,” “below” and “under” the second feature may include the first feature being directly below and obliquely below the second feature, or simply indicating that the first feature is at a lesser elevation than the second feature.

The present invention will be described in further detail with reference to the accompanying drawings.

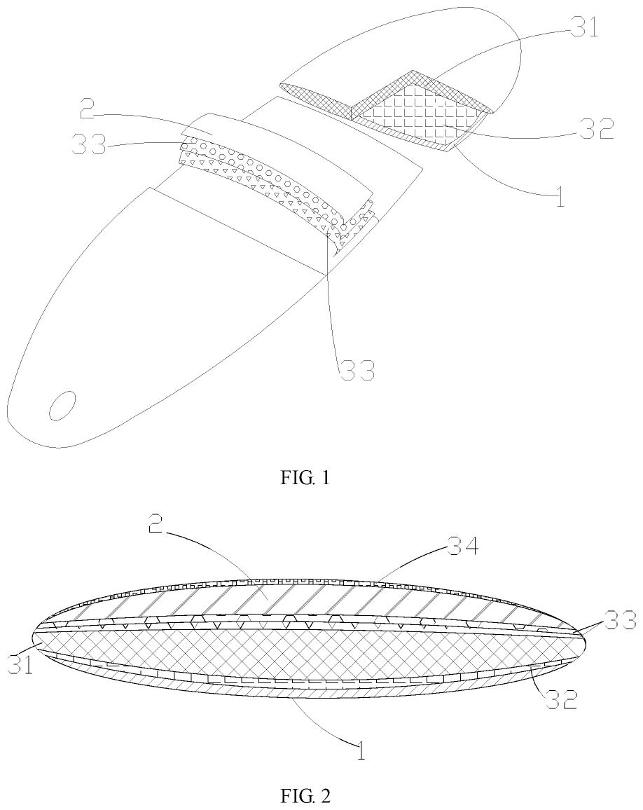

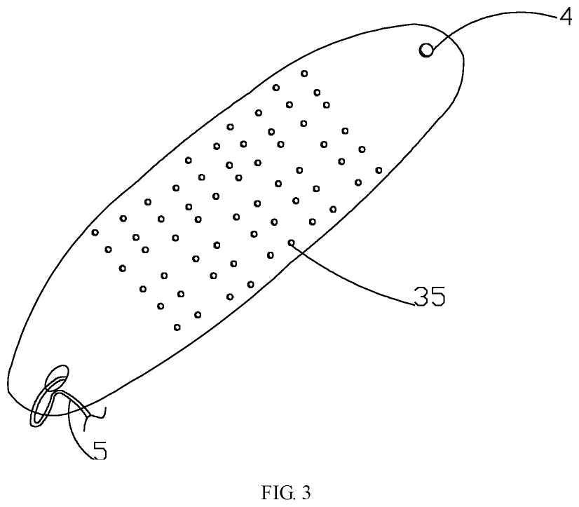

As shown in FIGS. 1 to 3, the present invention provides a paddle board, which comprises a body, and a bottom board layer 1 and a protective layer 2 disposed on two sides of the body; the body comprises a first glass fiber layer 32 arranged on the bottom board layer 1, an inner core 31 arranged on the first glass fiber layer 32 and a second glass fiber layer 33 arranged on the inner core 31 and connected with the protective layer 2; the second glass fiber layer 33 is provided with two layers.

In the embodiment, the bottom board layer 1 is arranged at the lower end of the body, so that the bottom of the paddle board is firmer. The upper end of the body is provided with the protective layer 2, so that the surface of the paddle board is protected, and the surface of the paddle board is prevented from being damaged when impacted by water pressure during use. Both the upper and lower end of the body are connected with the first glass fiber layer 32 and the second glass fiber layer 33 respectively, so that the connection between the bottom board layer 1 and the body and the connection between the body and the protective layer 2 are more stably.

In an optional embodiment, the material of the bottom board layer 1 is PC or ABS; PC is short for Polycarbonate, the English word for Polycarbonate is Polycarbonate, PC is amorphous thermoplastic resin with excellent comprehensive performance, and has excellent electrical insulation, extensibility, dimensional stability, chemical corrosion resistance, higher strength, heat resistance and cold resistance; the PC plastic also has the advantages of self-extinguishing, flame retardation, no toxicity, colorability and the like, shadows of PC plastic can be seen in all corners of our life, and the price is extremely low due to the characteristics of large-scale industrial production and easy processing; the bottom board layer 1 is made of the PC material, so that the bottom of paddle board is more firm, and need not to spray paint, logo can be directly printed on the bottom board layer 1, so it is more environmental friendly, and the environmental pollution can be effectively reduced.

In an optional embodiment, the material of the protective layer 2 is EVA or PE; the EVA foam is a biodegradable material and has the advantages of light weight, water resistance, high toughness and low price, so that the protective layer 2 made of the EVA foam can effectively reduce the generation cost and the quality of the paddle board, and the biodegradability of the EVA foam can solve the problem of environmental pollution caused by the traditional paddle board; PE, polyethylene (PE for short), is a thermoplastic resin obtained by polymerizing ethylene; the polyethylene is odorless and nontoxic, feels like wax, has excellent low-temperature resistance (the lowest use temperature can reach−100 to−70° C), has good chemical stability, and can resist the erosion of most of acid and alkali; the water absorption is low; therefore, the protective layer 2 made of PE materials can effectively ensure the stability of the internal structure of the paddle board.

In one embodiment, the material of the inner core 31 is foam; by utilizing the characteristics of light foam weight and easy floating in water, the weight of the paddle board can be effectively reduced, so that the buoyancy is increased, and a surfer can further more easily do high-difficulty surfing actions on water waves.

In one embodiment, the first glass fiber layer 32 is made of glass fiber cloth, and the second glass fiber layer 33 has two layers; the second glass fiber layer 33 is made of glass fiber cloth, and the first glass fiber layer 32 and the second glass fiber layer 33 are arranged on the upper side and the lower side of the inner core 31, so that the inner core 31 can be better connected with the bottom board layer 1 and the protective layer 2 under the stamping and pressing; specifically, the glass fiber cloth is 4 glass fiber cloth or 6 glass fiber cloth.

In the description of the present specification, references to the description of the terms “one embodiment,” “some embodiments,” “an example,” “a specific example,” or “some examples” or the like, mean that a particular feature, structure, material, or characteristic described in connection with the embodiment or example is included in at least one embodiment or example of the present utility mode. In this specification, the schematic representations of the terms used above do not necessarily refer to the same embodiment or example. Furthermore, the particular features, structures, materials, or characteristics described may be combined in any suitable manner in any one or more embodiments or examples.

The above is a further detailed description of the present invention in connection with the specific embodiments, and it is not intended that the invention be limited to the specific embodiments shown and described. For the ordinary technical person of technical field of the present invention, without departing from the concept of the present invention, a plurality of simple deductions or replacements can be made.

1. The surf board is characterized by comprising a body, a bottom board layer and a protective layer, wherein the bottom board layer and the protective layer are respectively arranged on two sides of the body; the body comprises a first fiber glass layer arranged on the bottom board layer, an inner core arranged on the first fiber glass layer and a second fiber glass layer arranged on the inner core and connected with the protective layer; the second fiber glass layer is provided with two layers.

2. The surf board of claim 1, wherein the material of the bottom board layer is PC or ABS.

3. The surf board of claim 1, wherein the material of the protective layer is EVA or PE.

4. The surf board of claim 1, wherein the material of the inner core is foam.

5. The surf board of claim 1, wherein the material of the first fiber glass layer is fiber glass cloth.

6. The surf board of claim 1, wherein the material of the second fiber glass layer is fiber glass cloth.
